(19) United States
(12) Patent Application Publication
(10) Pub. No.: US 2015/0174961 A1
(43) Pub. Date: Jun. 25, 2015

(54) REINFORCEMENT CORD FOR ELASTOMER PRODUCTS, IN PARTICULAR FOR A MOTOR VEHICLE AIR TIRE, AND MOTOR VEHICLE AIR TIRE

(71) Applicant: Continental Reifen Deutschland GmbH, Hannover (DE)

(72) Inventors: Thomas Kramer, Herford (DE); Wolfgang Reese, Peine (DE); Carole Justine, Scharrel (DE)

(21) Appl. No.: 14/642,397

(22) Filed: Mar. 9, 2015

Related U.S. Application Data
(63) Continuation of application No. PCT/EP2013/066514, filed on Aug. 7, 2013.

(30) Foreign Application Priority Data
Sep. 12, 2012 (DE) 10 2012 108 523.4

(51) Int. Cl. B60C 9/00; D02G 3/04; D02G 3/26; D02G 3/48

(52) U.S. Cl. CPC B60C 9/0042; B60C 9/005; D02G 3/48; D02G 3/045; D02G 3/26; B60C 2009/0092; D10B 2331/04; D10B 2331/02

(57) ABSTRACT

A reinforcement cord for elastomer products, in particular for a motor vehicle air tire, which includes at least one yarn. The reinforcement cord includes at least one yarn made from polyethylene furanate (PEF) which is produced entirely or at least in part from biomasses and/or renewable raw materials. Further, reinforcement cord can be provided as a hybrid cord made by twisting at least one yarn made from PEF with at least one yarn made from a different material, such as polyamide.

### CROSS REFERENCE TO RELATED APPLICATIONS

This application is a continuation application of international patent application PCT/EP2013/066514, filed Aug. 7, 2013, designating the United States and claiming priority from German application 10 2012 108 523.4, filed Sep. 12, 2012, and the entire content of both applications is incorporated herein by reference.

### FIELD OF THE INVENTION

The disclosure relates to a reinforcement cord for elastomeric articles of manufacture, in particular for a pneumatic vehicle tire, including at least one yarn.

The disclosure further relates to a pneumatic vehicle tire containing at least a reinforcement cord in accordance with the present invention.

### BACKGROUND OF THE INVENTION

Reinforcement cords as strength members for elastomeric articles of manufacture, in particular for strength member plies of pneumatic vehicle tires, such as carcass ply, bead reinforcer, belt ply and belt bandage, are known to a person skilled in the art in a very wide variety of embodiments with regard to construction and material. A rubber mixture is used to embed the reinforcement cords during production in order that they may be used as a rubberized strength member ply in the elastomeric article of manufacture.

Reinforcement cords contain one or more mutually twisted yarns. Two or more yarns thereof may comprise the same material or, as in the case of hybrid cords, two or more different yarns.

Elastomeric articles of manufacture, in particular carcass plies, bead reinforcers, belts or belt bandages of pneumatic vehicle tires, have hitherto utilized firstly textile strength members based in material terms primarily (directly) on fossil raw materials such as petroleum, examples including PET (polyethylene terephthalate), aramid and nylon or hybrid cords composed of yarns thereof.

On the other hand, it is known to use non-petroleum-based textile strength members composed of viscose, for example rayon or lyocell.

One disadvantage of natural fibers, that is, of non-petroleum-based materials, as material for textile strength members is that the fiber structure is not continuous and fiber quality is not consistent.

In addition, the nonexisting shrinkability in the specific case of rayon is not helpful to its use as a strength member in the belt bandage. A further disadvantage with rayon is that it is moisture sensitive and the breaking strength of the strength member decreases as a result of moisture imbibitions. What is more, rayon is cost intensive to procure.

The trend is toward elastomer products, such as pneumatic vehicle tires, that are environmentally friendly, resource sparing, eschewing primary fossil raw materials, to be developed and used without having to make sacrifices in the durability of the products produced therefrom. To wit, DE 10 2010 017 107 A1 discloses hybrid cords for, for example, carcass plies and/or belt bandages that consist at least of a yarn of recycled PET.

### SUMMARY OF THE INVENTION

The present disclosure, then, has for its object to provide a reinforcement cord for elastomeric articles of manufacture, in particular for a pneumatic vehicle tire, that includes at least one yarn, is an alternative to conventional reinforcement cords, comprises environmentally friendly and resource-sparing materials and is at the same time obtainable in a sustainable manner. In addition, the product quality of the reinforcement cord shall be consistent.

This object is achieved when at least one yarn of the reinforcement cord includes polyethylene furanate (PEF), wherein the PEF is wholly or at least partly produced from biomasses and/or renewable raw materials.

The structural formula of polyethylene furanate (PEF) is shown in formula (I). PEF is formally formed by polycondensation of monoethylene glycol (=MEG; 1,2-ethanediol) and furan-2,5-dicarboxylic acid.

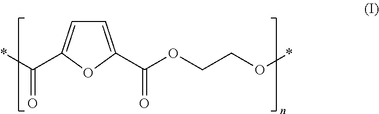

This polymer is known in the prior art regarding renewable raw materials not only as polyethylene furanate but also under the designation polyethylene furanoate. For the purposes of the present disclosure, PEF is to be understood as referring to a polymer as per structure (I).

In the context of this disclosure, the designations yarn of PEF and PEF yarn are used interchangeably. PEF produced wholly or at least partly from biomasses and/or renewable raw materials is also referred to herein as “PEF from wholly or at least partly from biomasses and/or renewable raw materials”.

The use of PEF from biomasses and/or renewable raw materials in the reinforcement cord for strength members of elastomer products that is in accordance with the present disclosure is sustainable, environmentally friendly and resource sparing. In addition, PEF produced wholly or at least partly from biomasses and/or renewable raw materials has, like PEF obtained from fossil raw materials only, a consistent quality. Consistent product quality is accordingly ensured.

In this context, the phrase “PEF produced wholly or at least partly from renewable raw materials” is to be understood as meaning that the PEF in material terms is produced wholly or at least partly from biomasses and/or renewable raw materials—irrespective of the energy source involved in the production. PEF consisting wholly or at least partly of biomasses and/or renewable raw materials is not obtained from fossil raw materials such as petroleum either exclusively or at all (that is, to an extent of 0 wt %).

As a person skilled in the art will know, the proportion of biobased materials, that is, the proportion derived from renewable raw materials and/or biomasses, in the PEF can be determined by the C-14 method of ASTM D 6866.

Biomasses in the context of the invention are “the entirety of any organic material formed by animals, plants or microorganisms through growth and metabolism” (RÖMPP, Online Lexikon, Version 3.25). Renewable raw materials are agricultural and forestry products intentionally grown and/or used by humans for purposes other than for food or feed. Renewable raw materials accordingly exclude fossil sources, such as petroleum, which are accessible by quarrying or mining.

However, the reinforcement cord of the present disclosure may contain PEF produced wholly or at least partly from monomers grown for use as food or feed, but because of a redistribution of raw materials, for example, are used not as food or feed but as renewable raw materials for service in the reinforcement cord. Any conflicts relating to the cultivation areas for raw materials should accordingly not have a restricting effect on the materials of the present disclosure.

The production of PEF is based on furan-2,5-dicarboxylic ester monomer, which is preferably obtained from biomasses, as described in United States patent application publication 2011/0282020 for example.

It is also conceivable for furan-2,5-dicarboxylic acid monomer to be obtained from biomasses and used for the production of PEF.

It is preferable to use renewable raw material derived from plants. To wit, monoethylene glycol monomer for PEF is preferably obtained from renewable plant-derived raw materials such as, for example, sugar cane or molasses, and not from petroleum.

Monoethylene glycol from plant-derived raw materials is already commercially available. The mass fraction of monoethylene glycol in PEF is 24.2%, based on the molecular weight of monoethylene glycol. The other monomer, furan-2,5-dicarboxylic ester, is present in polyethylene furanate at 75.8 wt %, based on the molecular weight of the monomer. Both the monomers are preferably manufactured from renewable raw materials. However, it is also conceivable for just one of the monomers to be manufactured from renewable raw materials. For example, a PEF produced from monoethylene glycol from purely plant-derived raw materials and furan-2,5-dicarboxylic ester from purely fossil raw materials consists of renewable raw materials to an extent of 24.2 wt %.

Further, either of the two monomers or both of them can be in the form of a mixture, in which case the monomer or monomers then come partly from renewable raw materials and partly from petroleum.

Additionally, each one of the monomers furan-2,5-dicarboxylic acid or furan-2,5-dicarboxylic ester and ethylene glycol (1,2-ethanediol) can be obtained wholly from biomasses or renewable raw materials.

PEF produced wholly or at least partly from biomasses and/or renewable raw materials may additionally contain impurities, such as organic hydrocarbons, that are attributable to the biomasses used and also to the plant-derived raw materials. Saccharides may be concerned here, for example.

At least one PEF yarn of the reinforcement cord disclosed herein comprises wholly or at least partly biomasses and/or renewable raw materials. The PEF here may be composed, for example, in accordance with the following embodiments.

### DESCRIPTION OF THE PREFERRED EMBODIMENTS OF THE INVENTION

In one preferred embodiment, the PEF is based on biomasses and/or renewable raw materials to an extent of from 10 to 100 wt %, preferably from 50 to 100 wt % and more preferably from 70 to 100 wt %, while the remaining wt %, which are not PEF from wholly or at least partly biomasses and/or renewable raw materials, are in the case of 100 wt % PEF directly manufactured from petroleum.

One possibility here is, for example, that only furan-2,5-dicarboxylic acid monomer is obtained from biomasses or renewable raw materials, while monoethylene glycol (1,2-ethanediol) monomer is obtained directly from petroleum, that is, for the PEF to be based on biomasses and/or renewable raw materials to an extent of 75.8 wt % and of petroleum-based raw materials to an extent of 24.2 wt %.

It is also within the scope of this disclosure for only monoethylene glycol monomer to be obtained from renewable raw materials, while furan-2,5-dicarboxylic acid monomer is obtained from petroleum, that is, for the PEF to consist of renewable raw materials to an extent of 24.2 wt % and of petroleum-based raw materials to an extent of 75.8 wt %.

In order that petroleum may be dispensed with entirely as primary material source for PEF, it is particularly preferable for the PEF to be based wholly, that is, to an extent of 100 wt %, on biomasses and/or renewable raw materials.

Hereinbelow “PEF from wholly or at least partly biomasses and/or renewable raw materials” is also condensed to “PEF from biomasses and/or renewable raw materials.” However, the abovementioned embodiments featuring fractions of petroleum-based raw materials are always included.

The at least one yarn of PEF from biomasses and/or renewable raw materials in the reinforcement cord of the present invention has a single twist of 100 to 600 t/m, preferably 100 to 550 t/m and more preferably 200 to 550 t/m.

Preferably, the reinforcement cord contains at least one further yarn, wherein the at least one yarn of PEF from wholly or at least partly biomasses and/or renewable raw materials and the at least one further yarn have a cable twist of 100 to 600 t/m, preferably 100 to 550 t/m and more preferably 200 to 550 t/m.

In one preferred embodiment, all the yarns of the cord comprise PEF from (wholly or at least partly) biomasses and/or renewable raw materials.

As a result, a customary PET reinforcement cord for example may be replaced by a reinforcement cord comprising PEF from biomasses and/or renewable raw materials. PEF has a glass transition temperature of 86° C., which is higher than that of polyethylene terephthalate at 74° C. The consequence of this is that, when the material is used for reinforcement cords in strength member plies of pneumatic vehicle tires, the tire does have the expected enhanced dimensional stability for PEF over PET.

Depending on the choice of production parameters, a reinforcement cord comprising at least one PEF yarn has similar properties to a PET reinforcement cord (regular or HMLS high modulus low shrinkage) of the customary type, that is, produced in material terms directly from petroleum.

However, properties similar to a polyamide reinforcement cord can also be established, depending on the choice of production parameters.

In a further preferred embodiment, the reinforcement cord is a hybrid cord wherein at least one yarn of the cord includes some other material than PEF from biomasses and/or renewable raw materials while the other yarn or yarns consist of PEF from biomasses and/or renewable raw materials. The reinforcement cord is thus partly sustainable, environmentally friendly and resource sparing and offers as a further advantage the option of modifying the reinforcement cord in a defined manner through a purposive selection of the material for the at least one further yarn.

In an advantageous embodiment, the reinforcement cord comprises at least one yarn of PEF from biomasses and/or renewable raw materials and at least one yarn of PET produced directly from petroleum and/or from recycled PET.

In a further advantageous embodiment, the reinforcement cord includes at least one yarn of PEF from wholly or at least partly biomasses and/or renewable raw materials and at least one further yarn of a nonmetallic material. The nonmetallic material is selected from the group consisting of polyamide (PA) and/or aramid and/or polyetherketone (PEK) and/or polyketone (POK) and/or polyethylene naphthalate (PEN) and/or rayon and/or viscose and/or natural fibers and/or glass fibers.

The overall hybrid cord is thereby very largely or entirely produced from materials not primarily based on petroleum, and may have modified properties due to a defined selection of suitable materials for the yarns.

To obtain higher shrinkage for the reinforcement cord, a further advantageous embodiment provides as preferable for the reinforcement cord to include at least one yarn of PEF from wholly or at least partly biomasses and/or renewable raw materials and at least one yarn of polyamide (PA). This is advantageous in particular for using this hybrid cord in the belt bandage of a passenger car tire.

It is particularly preferable for the PA yarn to include PA6.6 and/or PA6 fibers and/or PA10.10 fibers and/or PA10.12 fibers.

It is very particularly preferable for the PA yarn to comprise or to consist of PA6.6 fibers.

To obtain a higher modulus for the reinforcement cord, at least one yarn of PEF from wholly or at least partly biomasses and/or renewable raw materials and at least one yarn of aramid are used. This is advantageous in particular for using this hybrid cord in the belt bandage of ultra high performance (UHP) tires.

To obtain a stable reinforcement cord substantially devoid of shrinkage, at least one yarn of PEF from wholly or at least partly biomasses and/or renewable raw materials and at least one yarn of rayon are used. This is advantageous in particular for using this hybrid cord in the carcass of passenger car tires and for the high-speed behavior of passenger car tires.

It is advantageous for the linear density of every yarn making up the reinforcement cord to be between 200 and 5000 dtex and for the twist of the single twist materials to be between 100 and 600 t/m.

The yarns used for the reinforcement cord may each be constructed of S- or Z-twisted fibers. For instance, the PEF yarn from biomasses and/or renewable raw materials may be S- or Z-twisted.

The twisted yarns are cabled into a reinforcement cord by twisting in the S- or in the Z-direction. Advantageously, the yarns of a reinforcement cord all have the same direction of twist, that is, they are either S- or Z-twisted. In this advantageous version, the reinforcement cord has a cable twist in the direction opposite to the single twist of the yarns. For instance, an S-twisted PEF yarn from biomasses and/or renewable raw materials and an S-twisted aramid yarn may be Z-cabled into a reinforcement cord.

To ensure reliable adherence of textile strength members to the rubber, it is advantageous to provide an adhesive impregnation to the reinforcement cord of the present invention, for example via an RFL dip in a 1- or 2-bath process.

The disclosure also provides a pneumatic vehicle tire which contains at least a reinforcement cord as disclosed herein. Preferably, the pneumatic vehicle tire contains the reinforcement cord in the carcass ply and/or in at least one belt ply and/or as bead reinforcer and/or in the belt bandage. It is particularly preferable for the pneumatic vehicle tire to contain the reinforcement cord in the carcass ply.

It is understood that the foregoing description is that of the preferred embodiments of the invention and that various changes and modifications may be made thereto without departing from the spirit and scope of the invention as defined in the appended claims.

What is claimed is:

1. A reinforcement cord for elastomeric articles of manufacture, including at least one yarn, wherein the at least one yarn comprises polyethylene furanate (PEF) which is wholly or at least partly produced from biomasses and/or renewable raw materials.

2. The reinforcement cord as claimed in claim 1, wherein the PEF is produced from biomasses and/or renewable raw materials in an amount of from 10 to 100 wt %.

3. The reinforcement cord as claimed in claim 1, wherein the at least one yarn of PEF has a single twist of 100 to 600 t/m.

4. The reinforcement cord as claimed in claim 1, wherein the reinforcement cord contains at least one further yarn, and wherein the at least one yarn of PEF and the at least one further yarn have a cable twist of 100 to 600 t/m.

5. The reinforcement cord as claimed in claim 1, wherein all yarns of the reinforcement cord consist of PEF from wholly or at least partly biomasses and/or renewable raw materials.

6. The reinforcement cord as claimed in claim 1, wherein the reinforcement cord consists of at least one yarn of PEF from wholly or at least partly biomasses and/or renewable raw materials and at least one further yarn of a nonmetallic material.

7. The reinforcement cord as claimed in claim 1, wherein the linear density of every yarn is between 200 and 5000 dtex and wherein the respective twist of every yarn is between 100 and 600 t/m.

8. A pneumatic vehicle tire, comprising at least a reinforcement cord as claimed in claim 1.

9. The pneumatic vehicle tire as claimed in claim 8, wherein the tire contains at least a reinforcement cord in the carcass ply and/or in at least one belt ply and/or as bead reinforcer and/or the belt bandage.
